(19) United States
(12) Patent Application Publication
(10) Pub. No.: US 2021/0264910 A1
(43) Pub. Date: Aug. 26, 2021

(54) USER-DRIVEN CONTENT GENERATION FOR VIRTUAL ASSISTANT

(71) Applicant: Answer Anything, LLC, Carnation, WA (US)

(72) Inventor: Dana Young, Carnation, WA (US)

(73) Assignee: Answer Anything, LLC, Carnation, WA (US)

(21) Appl. No.: 16/802,395

(22) Filed: Feb. 26, 2020

(51) Int. Cl. G10L 15/22; G06N 3/00; G06F 16/242; G06F 16/23; G06Q 30/06; G06Q 50/16; G10L 15/18; G10L 15/30

(52) U.S. Cl. CPC G10L 15/22; G06N 3/006; G06F 16/243; G06F 16/2379; G10L 2015/223; G06Q 50/16; G10L 15/1815; G10L 15/30; G06Q 30/0625

(57) ABSTRACT

A computer system with access to a database of curated content receives a content request (e.g., based on words spoken by a human user interacting with a virtual assistant). The content request relates to a feature of a property (e.g., a vacation rental house) or an area in which the property is located. The computer system determines, based on analysis of the content request, that curated content related to the content request is not available in the database. The computer system transmits a representation of the content request to a property host computing device or a location-based search service. The computer system receives content from the host computing device or search service, which is responsive to the content request. The received content may then be presented to a user (e.g., via email, SMS message, or as synthesized voice output generated by the virtual assistant).

### BACKGROUND

Voice-enabled virtual assistants (Siri, available from Apple Inc., Google Assistant, available from Google Inc., or Alexa, available from Amazon.com, Inc.) are typically geared towards general consumer use such as computer-assisted searching, purchasing items, and other general tasks. In a typical scenario, a user speaks a “wake word” to activate the virtual assistant, followed by a question or command. In response, the virtual assistant uses natural language processing (NLP) to parse the user's statement and query a database, or a collection of databases, to obtain a response to the question. The response is formulated in text that is processed and output as a synthesized voice (e.g., via a smart phone or a voice-enable speaker (or smart speaker), such as the Echo, available from Amazon.com, Inc., or Google Home, available from Google Inc.).

As its name implies, NLP refers to processing of natural human language, within the broader context of automatic speech recognition (ASR). ASR includes basic processing such as automatic speech-to-text (STT) processing, in addition to more specialized processing, such as NLP. In turn, natural language understanding (NLU) refers to more advanced processing of natural human language, within the broader context of NLP. NLU concepts include semantic parsing, paraphrasing and summarization, natural language inference, and dialogue agents. NLP concepts that do not rise to the level of NLU include part-of-speech tagging, named entity recognition, text categorization, and syntactic parsing.

Computers do not have the ability to understand the correct context of speech, or provide appropriate responses to users' statements or questions, without specialized training. Therefore, in order to be effective, applications based on NLU require prior knowledge of what may be asked by a user. For this reason, NLU is typically employed for a narrow range of general tasks that are generally applicable to a wide variety of users, such as Internet searching, playing music, making lists, placing calls, composing messages, updating calendars, or purchasing items.

Once trained, a computer with NLU functionality will attempt to match a statement or question with a context that it has been programmed to understand. For example, a user may say, “Set a timer for five minutes.” A virtual assistant that has been programmed to set timers may note the presence of the words “set,” “timer,” and “five minutes” in this statement, and respond by setting a timer that expires in five minutes. This is an example of a broadly applicable context that could potentially be of value to any user, regardless of the user's location or situation.

On the other hand, consider a scenario in which a user has recently arrived in a vacation rental home equipped with a voice-enabled speaker and virtual assistant. The user is planning to watch a movie and wants to know if there is a home theater sound system available. In an attempt to find the sound system, the user may ask, “Where is the sound system?” This question has no useful responses without knowledge of the specific context of the question, as well as the features and layout of the home in which the question is asked. Therefore, a useful response would typically require specialized training and programming Such programming may allow a virtual assistant to interpret “Where is the sound system?” as a request about the presence and location of the sound system in that rental home, and to provide a response such as, “The sound system is located in the cabinet near the TV in the living room.” However, in order to provide this functionality, the virtual assistant must be programmed to understand the context of the user's question, as well as provide the correct information to respond to the question.

Although programming of this nature is achievable, it is also time-consuming and expensive and raises several technical problems to overcome. For example, a software developer who knows generally what a user may ask must expand the potential ways the user's intent may be verbalized and train the NLP engine to handle them effectively. In the situation illustrated above, a usable system should be able to handle “Where is the sound system?” as well as variations such as, “Tell me where the home theater system is.” Yet, this effort would be wasted for deployment in homes that lack a home theater system. Furthermore, if additional needs arise, the software must be reprogrammed to handle them. If a new projector is installed in a media room in the rental home, the software must be reprogrammed to not only recognize new vocabulary such as “projector,” but to recognize and answer common questions about it, such as how to turn it on and off. Thus, there are substantial technical barriers to implementing and maintaining a system of this nature.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a method of using a voice-based information retrieval system as a virtual concierge service for a real property (e.g., a private property, a rental property, a public property, or a combination thereof) is described. The method is performed by a computer system having access to a database of curated content. The computer system receives a content request based on one or more uttered words (e.g., words spoken by a human user, such as a guest at the property). The content request relates to a feature of the real property or an area in which the real property is located. The computer system determines, based at least on part on analysis of the content request, that curated content related to the content request is not available in the database. The computer system transmits a representation of the content request to a property host computing device (e.g., immediately, or delaying transmission until a designated time set by the host). The computer system receives host content from the property host computing device responsive to the content request. The received host content may then be added to the database to respond to future content requests.

In an embodiment, the computer system receives a second content request that relates to the area in which the real property is located, rather than the property itself. The computer system determines whether curated content related to this content request is available in the database and, in a case where curated content is not available, the computer system transmits a representation of the second content request to a location-based search service and receives content responsive to the second content request from the location-based search service.

In an embodiment, the one or more uttered words are received by a virtual assistant at a client device (e.g., a mobile computing device or voice-enabled speaker), and virtual assistant interprets the one or more uttered words as a content request. The virtual assistant need not have been previously trained for natural language understanding (NLU) of the content request. Indeed, the ability for the system to respond without such training provides significant benefits over systems that lack the ability to respond effectively to requests for which they have not been specifically trained.

In another aspect, a computer system having access to a database of curated content receives a content request and determines, based at least on part on analysis of the content request, that curated content related to the content request is not available in the database. The computer system determines whether the content request relates to an area in which the real property is located or a feature of the real property itself. In a case where the content request relates to the area in which the real property is located, the computer system transmits a representation of the content request to a location-based search service and receives content responsive to the content request from the location-based search service.

Content received from a host computing device and/or a location-based search service may be transmitted to the client device and presented to a user (e.g., via email, SMS message, a messaging application, synthesized voice output generated by the client device, etc.). Analysis of the content request(s) may include extracting one or more terms from the content request(s) and comparing the one or more extracted terms with voice topic tags associated with content in the curated content database.

Computer systems comprising one or more computing devices programmed to perform methods described herein are also described.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computer system in which described embodiments may be implemented;

FIG. 2 is a flow chart of an illustrative process for using a voice-based information retrieval system as a virtual concierge service for a property;

FIG. 3 is a flow chart of another illustrative process for using a voice-based information retrieval system as a virtual concierge service for a property; and

FIG. 4 is a block diagram that illustrates aspects of an illustrative computing device appropriate for use in accordance with embodiments of the present disclosure.

### DETAILED DESCRIPTION

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

In described embodiments, a computer system with access to a database of curated content receives a content request (e.g., based on one or more words spoken by a human user interacting with a virtual assistant). The content request relates to a feature of a property (e.g., a vacation rental house) or an area in which the property is located. The computer system determines, based on analysis of the content request, that curated content related to the content request is not available in the database. The computer system transmits a representation of the content request to a property host computing device or a location-based search service. The computer system receives content from the host computing device responsive or search service, which is responsive to the content request. The received content may then be presented to a user (e.g., via email, SMS message, a messaging application, as synthesized voice output generated by a virtual assistant, etc.).

Described embodiments overcome technical problems of previous systems. For example, the computer system need not have been previously trained for natural language understanding (NLU) of the content request in order to respond effectively to content requests. Indeed, the ability for the system to respond without such training provides significant benefits over systems that lack the ability to respond effectively to requests for which they have not been specifically trained.

In order to allow custom content to be defined without reprogramming the application, an interface is provided that can be accessed and used by a non-technical person. The interface can be provided as a web-based portal, with corresponding content stored in a database. An administrator (e.g., a property manager or owner) may access and provide contextual content via the portal with any suitable computing device, such as a smart phone, tablet, or a notebook or desktop computer that is connected to the Internet.

A client device (e.g., a smart speaker implementing a virtual assistant) can then access the custom content to provide a customized interactive voice-based information retrieval experience for a given use case without extensive reprogramming of the system. In some embodiments, a fully dynamic information retrieval structure allows any number of items to be defined and organized uniquely to a given host or author's needs.

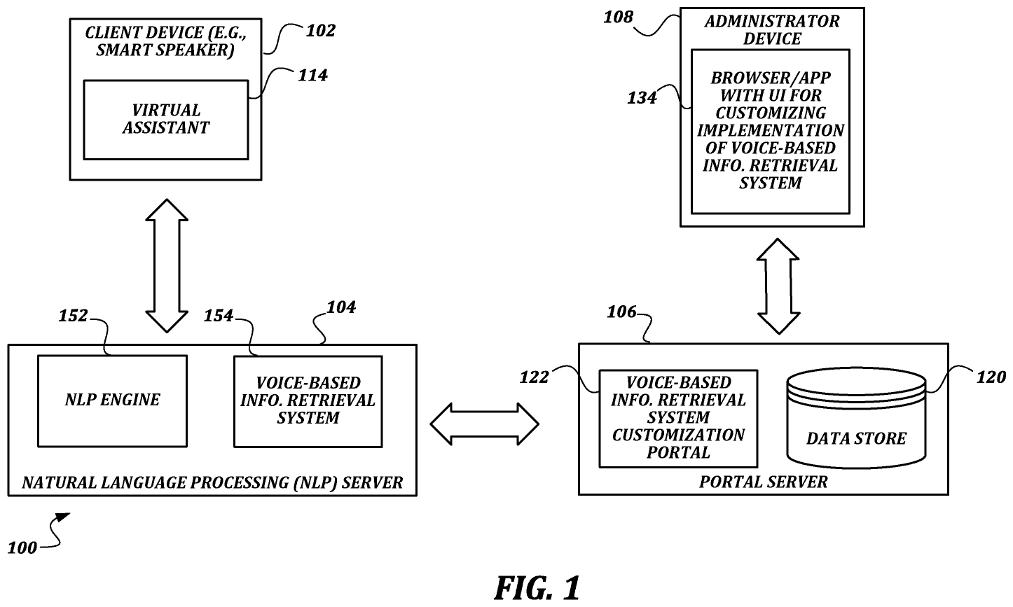

FIG. 1 is a block diagram of a computer system in which described embodiments may be implemented. In the example shown in FIG. 1, the system 100 includes a client device 102 (e.g., a smart speaker), a natural language processing (NLP) server 104, a portal server 106, and an administrator device 108. The client device 102 implements a virtual assistant 114 that communicates with the NLP server 104, which implements an NLP engine 152 and a voice-based information retrieval system 154.

In described embodiments, the voice-based information retrieval system 154 is used as a virtual concierge service for real property such as houses, buildings, hotels, resorts, parks, event spaces, shopping malls, rental properties (e.g., apartments, rental homes) or combinations thereof. In an embodiment, the client device is located on the real property in question. Alternatively, the client device may be located elsewhere (e.g., at a leasing or sales office). Although examples described herein refer to use cases involving rental properties, it should be understood that the technology described herein can be easily applied to privately owned properties (e.g., for personal guests of a homeowner), public properties, or private properties that are accessible to the public, such as resorts and shopping malls. As another example, the technology described herein can be used in other scenarios, such as a tool for real estate agents, brokers, or property owners listing a property for sale or rent. In such a scenario, the virtual concierge service or aspects thereof may be used to assist prospective property buyers, renters, real estate agents, apartment brokers, or the like to learn more about a property, e.g., as a virtual sales agent or leasing agent.

The NLP engine 152 provides functionality for natural language understanding (“NLU”) of at least some speech input provided to the virtual assistant 114 for interacting with the voice-based information retrieval system 154. The NLP server 104 also communicates with the portal server 106, which implements a customization portal 122 for the voice-based information retrieval system and includes a data store 120. The portal server 106 also communicates with an administrator device 108, which provides an interface 134 (e.g., via a web browser or custom application) for customizing an implementation of the voice-based information retrieval system. In some embodiments, as described in further detail below, the interface 134 includes features for obtaining content from property hosts (e.g., owners, managers, sales agents or brokers, homebuilders, or the like) that is responsive to content requests from guests. This content can be added to a curated content database (e.g., in data store 120) to respond to content requests, as described in further detail below. Content also can be delivered in other ways, such as by presenting menu options to a user via a voice interface (e.g., “say ‘house’ to hear more about the house, or say ‘activities’ to hear about things to do in the area”), and delivering corresponding content or additional menu options when a particular menu option is selected by the user.

Many alternatives to the arrangement shown in FIG. 1 are possible. For example, although a single client device and a single administrator device are shown for ease of illustration, it should be understood that the system can be easily extended to accommodate multiple client devices and multiple implementations of the voice-based information retrieval system, as well as multiple administrator devices. Multiple client devices may access the same implementation of the voice-based information retrieval system, or such devices may access different implementations (e.g., for different properties). Multiple administrator devices may access the same customization portal to customize the same implementation of the voice-based information retrieval system, or such devices may access different portals to customize different implementations. As another example, although the client device 102 is shown as implementing the virtual assistant 114 for purposes of illustration, it should be understood that functionality of the virtual assistant may be distributed across multiple computing devices, such as where the NLP engine 152 includes NLP functionality for the virtual assistant. As another example, although the NLP server 104 and the portal server 106 are illustrated as single servers in FIG. 1, it should be understood that the functionality provided by these each of these servers may, alternatively, be distributed across multiple computing devices. In one illustrative scenario, the functionality of the portal server 106 may be provided by a first server (or a set of multiple servers) that implements the customization portal 122 and a second server (or a set of multiple servers) that hosts the data store 120. In another illustrative scenario, the functionality of the NLP server 104 may be provided by a first server (or set of multiple servers) that implements the NLP engine 152 and a second server (or set of multiple servers) that hosts the voice-based information retrieval system 154.

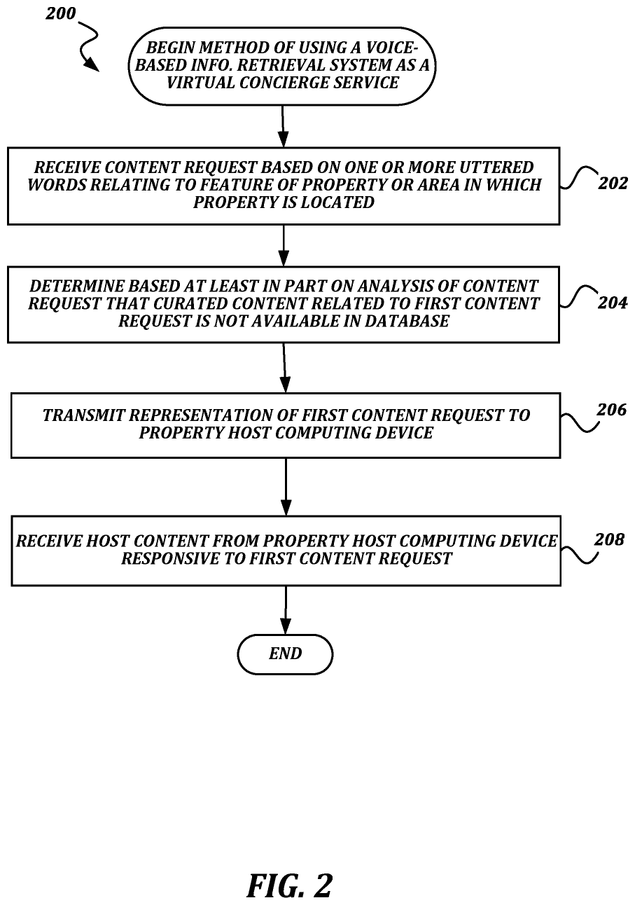

FIG. 2 is a flow chart of an illustrative process for using a voice-based information retrieval system as a virtual concierge service for a property. The process 200 may be performed by a computer system that implements a voice-based information retrieval system 154, such as the system 100 or one or more components thereof.

The computer system has access to a database of curated content for responding to content requests. As used herein, the term “curated content” refers to any content that is authored, generated, or selected (e.g., by a property owner or host) for responding to content requests. Curated content may include answers to frequently asked questions about a property, instructions relating to features of the property, recommendations for off-property activities, or the like. Curated content may include host-authored content, content authored by others, and/or automatically generated content (e.g., from a virtual assistant or location-based search service). Automatically generated content may be stored and approved or selected for future responses to content requests. Curated content may include text (which may in turn be converted to output input in the form of synthesized voice, video, or other output (e.g., from a virtual assistant)), images, video, audio, or any other type of content or combinations of content that may be useful for responding to content requests.

The process 200 begins at process block 202, in which the computer system receives a first content request based on one or more uttered words relating to a feature of a real property (e.g., a hotel, an apartment, a resort, a house, an event space, or a combination thereof) or an area in which the property is located. As used herein, the term “uttered words” refers to audio input that includes words, but is not limited to audible words spoken by a person. Uttered words also may include synthesized speech or any other type of audible words. In other embodiments, content requests may be based on other forms of expression, such as gestures detected by a camera-based gesture recognition system. At process block 204, the computer system determines, based at least in part on analysis of the first content request, that curated content related to the first content request is not available in the database.

In an embodiment, a user provides voice input including one or more uttered words to a virtual assistant 114 via the client device 102 (e.g., a smart speaker or smart phone), which interprets the voice input as a content request. The virtual assistant 114 provides the content request to the voice-based information retrieval system 154, which performs the analysis of the content request. The analysis may include extracting one or more terms from the content request and comparing the extracted terms with available content in the curated content database. For example, the computer system may use speech-to-text processing to convert the second speech input to text, and compare the resulting text with voice topic tags to determine if curated content is available to respond to the content request. Voice topic tags and illustrative uses thereof are described in further detail below.

At process block 206, having determined that curated content is not available to respond to the content request, the computer system transmits a representation of the first content request to a property host computing device (e.g., administrator device 108). The property host computing device may be associated with, e.g., a property owner, a property manager, a sales agent or broker, or the like. The representation may take the form of, e.g., a text transcript or summary (e.g., identification of topic) of the request. The mode of transmission of the representation of the content request may be in any appropriate form. For example, if the property host has opted in to be contacted for answers to content requests, the computer system may cause a communication (e.g., an SMS message, an email, a push notification of a mobile application, etc.) to be sent to the property host's smart phone or tablet computer, indicating that a guest has asked about a topic for which curated content is not available.

At process block 208, the computer system receives host content from the property host computing device responsive to the first content request. For example, the property host may use the property host computing device to navigate to a portal (e.g., portal 122) to add content responsive to the content request. Illustrative techniques and workflows for obtaining curated content responsive to content requests are described in further detail below.

The process 200 allows the computer system to determine whether curated content is available for a content request and take action to obtain responsive content even where the computer system has not been specifically trained for NLU of the first content request. Instead, the computer system may use other techniques that do not rise to the level of NLU of the entire content request to make the determination that curated content for the content request is not available in the database.

The process 200 can be extended or modified to any number of content requests, and content requests of different types. In an embodiment, the computer system receives a second content request that relates to off-property topic that relates to the area in which the property is located, rather than a feature of the property itself. The computer system determines whether curated content is available in the database for the off-property topic using one or more techniques described herein. In a case where curated content is not available in the database for the off-property topic, the computer system transmits a representation of the second content request to a location-based search service implemented by one or more server computers. The computer system receives a response to the second request from the location-based search service. Other options for processing content requests and illustrative uses of location-based search services are described in further detail below.

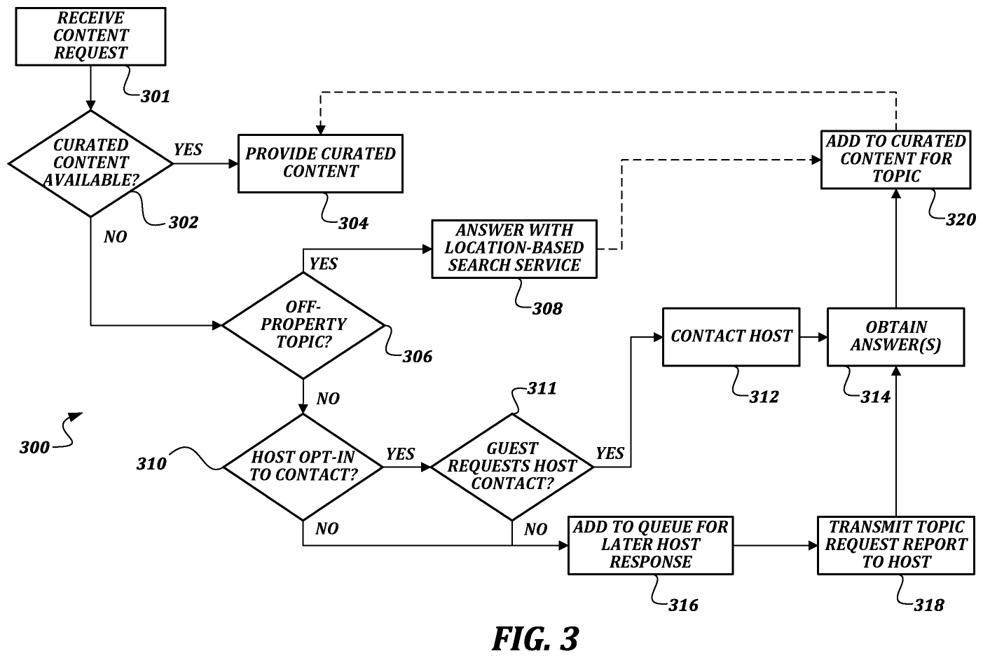

FIG. 3 is a flow chart of another illustrative process for using a voice-based information retrieval system as a virtual concierge service for a property. FIG. 3 includes a detailed workflow in which the process of FIG. 2 or other processes may be implemented. The process 300 begins at process block 301, in which a computer system (e.g., computer system 100) receives a content request (e.g., the first content request of process block 202 in FIG. 2). In an illustrative scenario, a guest activates a virtual assistant in order to provide the content request to the virtual assistant. This may be accomplished by uttering a wake word or phrase (e.g., “Alexa”) followed by a command (e.g., “[wake word], use the concierge service”; “[wake word], talk to the virtual concierge”; “[wake word], concierge”; “[wake word], [property name] information”; or “[wake word], house help.”

At process block 302, the computer system determines whether curated content corresponding to the content request is available in a database. If curated content is available that is relevant to the content request, the computer system transmits curated content to a client device (e.g., a smart phone, a tablet computer, a smart speaker at the property, etc.) at process block 304 for presentation to a user of the client device (e.g., via email, text message, audio or video message, synthesized voice output of a virtual assistant, etc.).

In the example shown in FIG. 3, if curated content is not available, the computer system performs different actions depending on whether the content request relates to an off-property topic (e.g., tourist activities in the area, restaurants in the area, etc.) At process block 306, the computer system determines whether the content request relates to an off-property topic. To make this determination, the computer system may analyze the content request to search for keywords relating to common off-property topics, such as restaurants, outdoor activities, shopping, popular tourist destinations, public transportation, or the like. For an off-property content request where curated content is not available, the computer system can answer the content request automatically (e.g., using a location-based search service such as Google Places) at process block 308.

In an illustrative scenario, a guest may ask, “Where is the best place to get ice cream?” Finding no curated content available relating to “ice cream,” the computer system identifies “ice cream” as an off-property topic and determines that the property host has opted in to automatic responses for off-property topics. The computer system transmits a representation of this request to a location-based search service, which may use the location of the property (either explicitly defined or inferred from other information, such as the location of the client device 102) to identify local options for ice cream shops or other businesses that serve ice cream. Once obtained, this content can be transmitted to the client device or some other computing device for presentation to a user. This content also can be added to curated content, if desired, at process block 320 for possible later use, for responding to subsequent content requests at the same property or other properties in the same area.

For on-property topics or other topics that cannot be answered automatically in process block 308, the system checks to see whether the host is to be contacted to obtain relevant content. At decision block 310, the computer system determines whether the property host has opted in be contacted (e.g., immediately, at a designated time selected by the host, etc.) for answers to guest questions. If the property host has opted in to be contacted, the computer system determines at decision block 311 whether the guest has requested that the host be contacted. This determination may be accomplished in various ways. As one example, the computer system may prompt the client device to ask the user (e.g., via the voice interface of a virtual assistant) whether the host should be contacted to respond to the content request.

If the guest has explicitly requested a host response, or otherwise consents to the host being contacted, the computer system sends a request to the host computing device at process block 312. For example, the request may be sent in a communication such as an SMS message or push notification, which may include a URL or other feature that allows the host to navigate to a portal (e.g., using a web browser or a dedicated host portal application) for providing content responsive to the content request. As another example, the request may be presented to the host via their own virtual assistant (e.g., “A guest at your rental property has requested information about the home theater system. Would you like to provide content to respond to this request?”). The portal can present a user interface (e.g., in the form of a step-by-step “wizard” interface, a virtual assistant dialog, or the like) to guide the host through the process of adding content responsive to the request. This content can be transmitted to the virtual assistant for presentation to the guest, and can also be added to the curated content for later presentation to other guests.

Referring again to the illustrative workflow of FIG. 3, the computer system receives responsive content at process block 314. The computer system adds this content to the curated content database at process block 320 and provides the content that responds to the content request to the client device at process block 304, if desired.

If the host has not opted in to be contacted, or if the guest has not requested it, the content request is added to a queue for later host response at process block 316. Queued content requests can be added to a topic report, potentially along with other topics that have already been answered. At process block 318, a topic report is transmitted (e.g., hourly, daily, twice a week, weekly, monthly, on-demand, or in any other time frame, which may be adjustable by the host) to the host computing device.

A topic report may include a list of topics, frequency of request for those topics, an indication of whether curated content was available to respond to the request, an indication of whether the request received a response, or other information. The computer system may send a notification (e.g., via email, SMS message, etc.) to the host computing device that a topic report is ready for review. The notification may include a URL or other feature that allows the host to navigate to a portal to review the report and provide content responsive to the topics in the topic report. The portal can present a user interface (e.g., in the form of a step-by-step “wizard” interface, a virtual assistant dialog, or the like) to guide the host through the process of adding content responsive to topics in the topic report. The computer system may then obtain responses to one or more topics from the topic report at process block 314. The content provided by the host for the responses may take any number of forms, including text, recorded audio, recorded video, or the like. The responsive content can be added to the curated content database at process block 320 presentation to the guest at process block 304, if desired. The content provided by the host may be presented to the guest in any suitable manner (e.g., text, video, audio, etc.), by any suitable device. For example, the content may be provided to the user via email, an SMS (Simple Messaging Service) or MMS (Multimedia Messaging Service) message, a voice call, a video call, a messaging application, a virtual assistant, or other delivery mechanisms. These delivery mechanisms or other delivery mechanisms also may be used to provide notifications, instructions, or links for accessing the content (e.g., at a remote server) rather than delivering the content directly.

In situations where content requests are answered automatically or with curated content, those content requests still may be added to the queue for later host response and added to topic reports as well, as in process blocks 316, 318. This can allow the host to see what their guests are asking about, and give hosts the option to supplement responses with other custom content, even where content requests have already been answered.

Curated content for off-property requests may include recommendations, and may include other content as well, such as promotion codes, links to digital coupons, or other promotional content. Some promotional content (e.g., coupons) that is not easily delivered via a voice interface may instead be sent to guests via email, SMS message, or the like.

In an illustrative scenario, a guest provides a content request by asking a virtual assistant, “Where are the spare pillows kept?” The virtual assistant transmits a representation of this content request to the computer system, which determines (e.g., by comparing keywords with voice topic tags in a curated content database) whether any curated content relating to spare pillows is available. If no relevant curated content is found, the computer system may prompt the virtual assistant to initially respond with a message indicating missing information, such as “I don't have information about where extra pillows are stored yet.” If the property host has opted in be contacted for answers to guest questions, the computer system may prompt the virtual assistant to ask the guest whether the host should be contacted, such as by asking, “Would you like me to contact your host for an answer?” If the guest approves, the computer system may cause an SMS message or other communication to be sent to a host computing device. The communication may include a URL or other feature that allows the host to navigate to a portal, as described above, for providing content responsive to the content request, such as “The spare pillows are in the linen closet in the hallway near the master bedroom.” This content can be transmitted to a computing device for presentation to the guest, and can also be added to the curated content for later presentation to other guests.

The process of matching content requests to available curated content can be performed in various ways. In some embodiments, voice topic tags can be used to disaggregate or decouple content items from an NLU model. With voice topic tags, content items do not need to be identified and pre-trained in the NLU model. Voice topic tags act as an intermediary, a separate entity that connects unique custom content to a set of words and phrases that are part of the NLU model. This approach allows the system to provide a natural-feeling conversation for the user, while also providing the flexibility to present custom content to a user without specialized NLU training. This approach also provides a significant increase in flexibility and utility. The NLU engine is pre-trained on a set of words and phrases, and a voice topic tag is connected to that set of words and phrases in the model. It is also connected to a custom content item defined by a property host or other administrator or author. By establishing these connections, a word or phrase of the set that is spoken by the user will result in the associated content item being delivered in response. This creates broad flexibility and utility for a host, allowing them to establish content items that do not need to be included in the NLU model, in such a way that unique content (including proper nouns) can be delivered to a user through a voice assistant with no NLU training required. Multiple voice topic tags can be associated with a single content item. Similarly, a given voice topic tag can be used for multiple content items.

Consider a scenario in which a host has a favorite family-friendly restaurant called “Bubba's Place” that also features games for kids. Using voice topic tags, a host may choose to tag content describing Bubba's Place with voice topic tags such as “restaurant” and “kids.” It will be possible for a user looking for a restaurant recommendation to access the Bubba's place content (e.g., by asking “Can you recommend a good restaurant?”) just as easily as a different user looking for kids' activities (e.g., “Tell me about activities for kids”). Yet, the system need not be specially programmed to provide information about Bubba's Place in response to questions about kid's activities or restaurants, or to provide a specific menu structure for restaurant recommendations or kids' activities. Instead, the “restaurant” and “kids” voice topic tags need only be applied to the content to allow it to be discovered by these two users. Further, voice topic tags can be defined to include synonyms or related concepts. For example, the host may tag an on-property content item titled “Garbage and Recycling” with a “garbage” voice topic tag, which may be defined such that the words “garbage,” “trash,” “recycling,” “composting,” “refuse,” and “rubbish” will all be recognized in a user's inquiry. In an illustrative scenario, a guest could say either “What do I do with the trash?” or “Give me information about recycling,” and in either case, the “Garbage and Recycling” content item will be provided.

Many alternatives to the processes and workflows described above are possible. For example, separate treatment of on-property and off-property topics can be omitted, in which case process blocks 306 and 308 of FIG. 3 may be omitted. This alternative may be useful where a host has opted to answer all topics with custom content, or where a location-based search service is not desirable or available. In such an embodiment, the workflow of FIG. 3 may proceed directly from decision block 302 to decision block 310, without regard to whether the content relates to an off-property or on-property topic. As another example, although examples described herein refer to transmission of transcripts or summaries of content requests to host computing devices, the host device may also receive recorded audio of the content request itself, which may be useful if the text transcript or topic summary is not clear or if the host requires further explanation. In an embodiment, the user is given the opportunity to consent to recording and/or transmission of recorded audio the property host for this purpose before such recording or transmission takes place.

### Illustrative Devices and Operating Environments

Unless otherwise specified in the context of specific examples, described techniques and tools may be implemented by any suitable computing device or set of devices.

In any of the described examples, an engine may be used to perform actions. An engine includes logic (e.g., in the form of computer program code) configured to cause one or more computing devices to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. The particular engines described herein are included for ease of discussion, but many alternatives are possible. For example, actions described herein as associated with two or more engines on multiple devices may be performed by a single engine. As another example, actions described herein as associated with a single engine may be performed by two or more engines on the same device or on multiple devices.

In any of the described examples, a data store contains data as described herein and may be hosted, for example, by a database management system (DBMS) to allow a high level of data throughput between the data store and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location. Alternatively, a peer-to-peer arrangement, or other models, can be used.

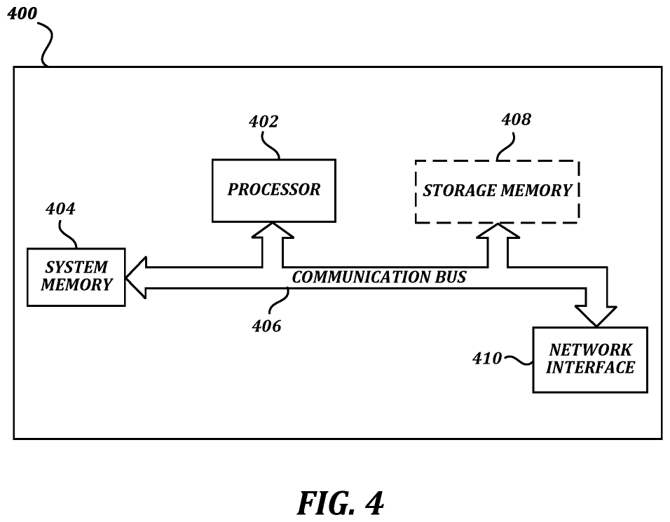

FIG. 4 is a block diagram that illustrates aspects of an illustrative computing device 400 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 400 includes at least one processor 402 and a system memory 404 connected by a communication bus 406. Depending on the exact configuration and type of device, the system memory 404 may be volatile or nonvolatile memory, such as read only memory (“ROM”), random access memory (“RAM”), EEPROM, flash memory, or other memory technology. Those of ordinary skill in the art and others will recognize that system memory 404 typically stores data and/or program modules that are immediately accessible to and/or currently being operated on by the processor 402. In this regard, the processor 402 may serve as a computational center of the computing device 400 by supporting the execution of instructions.

As further illustrated in FIG. 4, the computing device 400 may include a network interface 410 comprising one or more components for communicating with other devices over a network. Embodiments of the present disclosure may access basic services that utilize the network interface 410 to perform communications using common network protocols. The network interface 410 may also include a wireless network interface configured to communicate via one or more wireless communication protocols, such as WiFi, 2G, 3G, 4G, LTE, 5G, WiMAX, Bluetooth, and/or the like.

In FIG. 4, the computing device 400 also includes a storage medium 408. However, services may be accessed using a computing device that does not include means for persisting data to a local storage medium. Therefore, the storage medium 408 depicted in FIG. 4 is optional. In any event, the storage medium 408 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 404 and storage medium 408 depicted in FIG. 4 are examples of computer-readable media.

For ease of illustration and because it is not important for an understanding of the claimed subject matter, FIG. 4 does not show some of the typical components of many computing devices. In this regard, the computing device 400 may include input devices, such as a keyboard, keypad, mouse, trackball, microphone, video camera, touchpad, touchscreen, electronic pen, stylus, and/or the like. Such input devices may be coupled to the computing device 400 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 400 (e.g., a client device), or can be integral components of the computing device 400. In some embodiments, multiple input devices may be combined into a single, multifunction input device (e.g., a video camera with an integrated microphone). The computing device 400 may also include output devices such as a display, speakers, printer, etc. The output devices may include video output devices such as a display or touchscreen. The output devices also may include audio output devices such as external speakers or earphones. The output devices can be separate from and communicatively coupled to the computing device 400, or can be integral components of the computing device 400. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### Extensions and Alternatives

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Although illustrative embodiments are described with reference to a voice-enabled smart speaker and a voice-based information retrieval system, it should be understood that the devices and systems described herein need not be limited to voice or audio input and output. An information retrieval system that responds to voice input may be considered “voice-based” without being strictly limited to voice input or voice output. Thus, suitable client devices and administrator devices may include smart phones or other computing devices with touchscreens, video display functionality, and other features. For client devices with video display capability, a user may be presented with video content such as a welcome video or an instructional video, e.g., in response to selection of menu options. The portal may be augmented to provide administrators the ability to upload images, videos, audio files, or other media as custom content. In addition, smart speakers with touchscreen and video display functionality are contemplated, as well as other user interface devices such as virtual reality devices, which may include headsets paired with corresponding handheld devices or other input/output devices. At a suitably configured client device, a user may be provided with ability to, for example, point to, swipe, tap, or use some other action or gesture to interact with images representing menu items (e.g., things to do in the area), either in place of or in combination with navigating and selecting items with voice input. Similar capabilities can be incorporated in an administrator device, to provide administrators with additional options for customizing the system and providing custom content. As with a voice interface, an enhanced user experience with visual, touch, or virtual reality aspects is possible without the complexity of reprogramming or retraining the information retrieval system, in accordance with principles described herein.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations.

While illustrative embodiments have been illustrated and described, it will be appreciated that various changes can be made therein without departing from the spirit and scope of the invention.

1. A method of using a voice-based information retrieval system as a virtual concierge service for a real property, the method comprising, by a computer system having access to a database of curated content:
receiving a first content request based on one or more uttered words, wherein the first content request relates to a feature of the real property or an area in which the real property is located;
determining, based at least on part on analysis of the first content request, that curated content related to the first content request is not available in the database;
transmitting a representation of the first content request to a property host computing device; and
receiving host content from the property host computing device responsive to the first content request.

2. The method of claim 1, wherein the analysis of the first content request comprises extracting one or more terms from the first content request and comparing the one or more extracted terms with voice topic tags associated with content in the curated content database.

3. The method of claim 1 further comprising:
receiving a second content request, wherein the second content request relates to the area in which the real property is located;
determining whether curated content related to the second content request is available in the database; and
in a case where curated content related to the second content request is not available in the database:
transmitting a representation of the second content request to a location-based search service; and
receiving content responsive to the second content request from the location-based search service.

4. The method of claim 1 further comprising adding the host content to the database.

5. The method of claim 1, wherein transmitting the representation of the first content request to the property host computing device comprises delaying transmission of the representation until a designated time.

6. The method of claim 1 wherein the one or more uttered words are received by a virtual assistant at a client device, and wherein the virtual assistant interprets the one or more uttered words as the first content request.

7. The method of claim 6, wherein the virtual assistant has not been previously trained for natural language understanding (NLU) of the first content request.

8. The method of claim 7, wherein the virtual assistant is implemented in a mobile computing device.

9. The method of claim 7, wherein the virtual assistant is implemented in a voice-enabled speaker.

10. The method of claim 1, wherein the one or more uttered words are spoken by a human user.

11. The method of claim 1, wherein the real property comprises a private property, a rental property, a public property, or a combination thereof.

12. The method of claim 1 further comprising presenting the host content to a user.

13. A method of using a voice-based information retrieval system as a virtual concierge service for a real property, the method comprising, by a computer system having access to a database of curated content:
receiving a content request;
determining, based at least on part on analysis of the content request, that curated content related to the content request is not available in the database;
determining whether the content request relates to an area in which the real property is located or a feature of the real property itself;
in a case where the content request relates to the area in which the real property is located, transmitting a representation of the content request to a location-based search service; and
receiving content responsive to the content request from the location-based search service.

14. The method of claim 13, wherein the analysis of the content request comprises extracting one or more terms from the content request and comparing the one or more extracted terms with voice topic tags associated with content in the curated content database.

15. The method of claim 13 wherein the one or more uttered words are received by a virtual assistant at a client device, and wherein the virtual assistant interprets the one or more uttered words as the content request.

16. The method of claim 15, wherein the virtual assistant has not been previously trained for natural language understanding (NLU) of the content request.

17. The method of claim 15 further comprising transmitting the content received from the location-based search service to the client device for presentation via the virtual assistant.

18. A computer system comprising one or more computing devices programmed to, at least:
receive a first content request based on one or more uttered words, wherein the first content request relates to a feature of a real property or an area in which the real property is located;
determine, based at least on part on analysis of the first content request, that curated content related to the first content request is not available in a database;
transmit a representation of the first content request to a property host computing device; and
receive host content from the property host computing device responsive to the first content request.

19. The computer system of claim 18, wherein the analysis of the first content request comprises extracting one or more terms from the first content request and comparing the one or more extracted terms with voice topic tags associated with content in the curated content database.

20. The computer system of claim 18, wherein the one or more computing devices are further programmed to:
receive a second content request, wherein the second content request relates to the area in which the real property is located;
determine that curated content related to the second content request is not available in the database;
transmit a representation of the second content request to a location-based search service; and
receive content responsive to the second content request from the location-based search service.
